(19) United States
(12) Patent Application Publication
(10) Pub. No.: US 2019/0151810 A1
(43) Pub. Date: May 23, 2019

(54) Structured Shake

(71) Applicant: Richard Charles Russett, III, Memphis, TN (US)

(72) Inventor: Richard Charles Russett, III, Memphis, TN (US)

(21) Appl. No.: 16/258,637

(22) Filed: Jan. 27, 2019

Related U.S. Application Data
(63) Continuation-in-part of application No. 15/167,654, filed on May 27, 2016.

(51) Int. Cl. B01F 13/00; B65D 43/02; B01F 13/08; B65D 25/02; B65D 85/72

(52) U.S. Cl. CPC B01F 13/002; B65D 43/0202; A47J 43/27; B65D 25/02; B65D 85/72; B01F 13/0836

(57) ABSTRACT

This disclosure relates to a drink container with lid for the mixing and blending of liquids for consumption, wherein the unique design of the drink container tends to improve the texture and flavor of the liquid blended within it.

### CROSS-REFERENCE TO RELATED APPLICATIONS

Ser. No. 15/167,654 May, 2016 Russett

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

This disclosure relates to a beverage container with lid for the mixing, blending, storing, or drinking of liquids for consumption that improves the texture and flavor of the liquid blended within it by having a plurality of paired magnets positioned around the beverage container, wherein the plurality of paired magnets act on the liquid in the beverage container to improve the texture and flavor of the liquid.

### Background of the Invention

This application is a continuation in part of U.S. patent application Ser. No. 15/167,654 filed May 27, 2016. The benefit of the earlier filing date of the aforementioned U.S. patent application Ser. No. 15/167,654 is hereby claimed.

Some beverage additives begin as a powder, liquid or gel and are blended with water prior to being consumed. The texture and flavor of these beverage additives detract from the drinkability and flavor of the resultant beverage. Other beverages contain impurities that impact the taste of the beverage. The present disclosure reveals a beverage container with lid and a plurality of paired magnets for the purpose of mixing, blending, storing, or drinking a beverage. In the present disclosure, a plurality of paired magnets are positioned around a beverage container such that the magnetic field generated by the magnets act upon the liquid in the beverage container. Several advantages result from the present disclosure including, first, when a beverage additive is mixed with water in the beverage container the resultant beverage produced is smoother and has a superior taste over the same beverage additive mixed in other containers; and second, when a beverage is stored in the container, the container causes the impurities in the container to be restricted.

### SUMMARY OF THE INVENTION

The present disclosure reveals a beverage container comprising a main body, lid, and a plurality of paired magnets, wherein the plurality of paired magnets are positioned around the beverage container is such a fashion so as to generate a magnetic field that acts upon liquid contained in the beverage container. The main body comprises a top, an opening, a plurality of sides and a base. The lid is such that the lid fits over the opening of the main body to seal off the opening to prevent the liquid, powder or gel from escaping from the beverage container in the event the beverage container is tipped or shaken. Each magnet in a pair of magnets of the plurality of paired magnets is positioned in the beverage container such that one magnet is on one side of the beverage container while its pair is located on the opposite side of the beverage container. For the purpose of explanation of the disclosure only, the revealed disclosure will include the opening in the main body to be located at the top of the beverage container.

In determining the placement of each pair of magnets in the plurality of magnets a center-point of the beverage container is identified based on the beverage container's dimensions and from the center-point Cartesian coordinates can be extrapolated. Thus, a positive z-axis intersects the top of the beverage container and a negative z-axis intersects the base of the beverage container; a positive x-axis intersects one of the sides of the plurality of sides of the beverage container and a negative x-axis intersects one of the sides of the plurality of sides of the beverage container; and a positive y-axis intersects one of the sides of the plurality of sides of the beverage container and a negative y-axis intersects one of the sides of the plurality of sides of the beverage container.

In a first embodiment of the plurality of paired magnets the first set of paired magnets is positioned along the y-axis wherein the first magnet is positioned along the positive z-axis, in the top of the beverage container and the other magnet is positioned along the negative z-axis in the base of the container.

In a second embodiment of the plurality of paired magnets there are two sets of paired magnets wherein the first set of paired magnets is positioned along the z-axis wherein the first magnet is positioned along the positive z-axis, in the top of the beverage container and the other magnet is positioned along the negative z-axis in the base of the container, while the second set of paired magnets is positioned along the x-axis, having the first magnet positioned along the positive x-axis in one of the plurality of sides of the beverage container and the second magnet positioned along the negative x-axis in one of the plurality of sides of the beverage container.

In a third embodiment of the plurality of paired magnets there are three sets of paired magnets wherein the first set of paired magnets is positioned along the z-axis having the first magnet is positioned along the positive z-axis, in the top of the beverage container and the other magnet is positioned along the negative z-axis in the base of the container, while the second set of paired magnets is positioned along the x-axis, having the first magnet positioned along the positive x-axis in one of the plurality of sides of the beverage container and the second magnet positioned along the negative x-axis in one of the plurality of sides of the beverage container, while the third set of paired magnets is positioned along the y-axis, having the first magnet positioned along the positive y-axis in one of the plurality of sides of the beverage container and the second magnet positioned along the negative y-axis in one of the plurality of sides of the beverage container.

Additional magnet sets in the plurality of magnets are possible, wherein each magnet in the set of magnets is positioned so as to oppose its pair.

### BRIEF DESCRIPTION OF THE SEVERAL VIEWS OF THE DRAWING

FIG. 1 is a view of the beverage container including the main body and lid, with the Cartesian coordinates interposed on the beverage container;

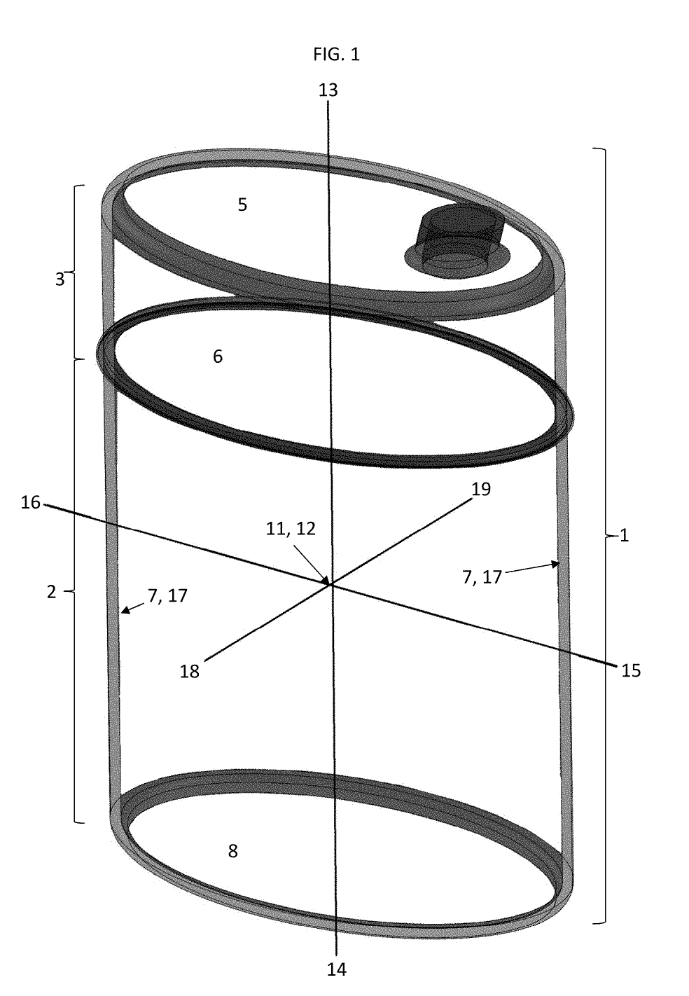

FIG. 2 is a view of the first embodiment of the beverage container including the first set of paired magnets of the plurality of paired magnets, wherein one of the magnets is positioned along the positive z-axis in the top of the beverage container and the other magnet is positioned along the negative z-axis in the base of the beverage container;

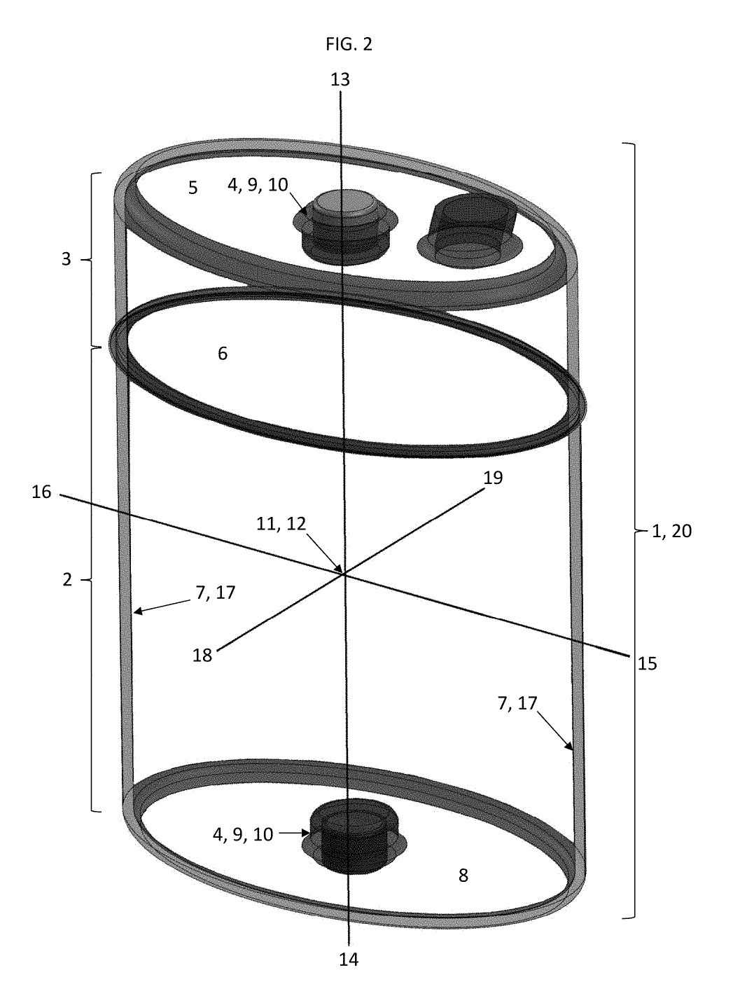

FIG. 3 is a view of the second embodiment of the beverage container including two pairs of magnets wherein the first set of paired magnets of the plurality of paired magnets, wherein one of the magnets is positioned along the positive z-axis in the top of the beverage container and the other magnet is positioned along the negative z-axis in the base of the beverage container, and wherein the second set of paired magnets of the plurality of paired magnets, such that one of the magnets is positioned along the positive x-axis in one of the sides of the plurality of sides of the beverage container and the other magnet is positioned along the negative x-axis in one of the sides of the plurality of sides of the beverage container; and

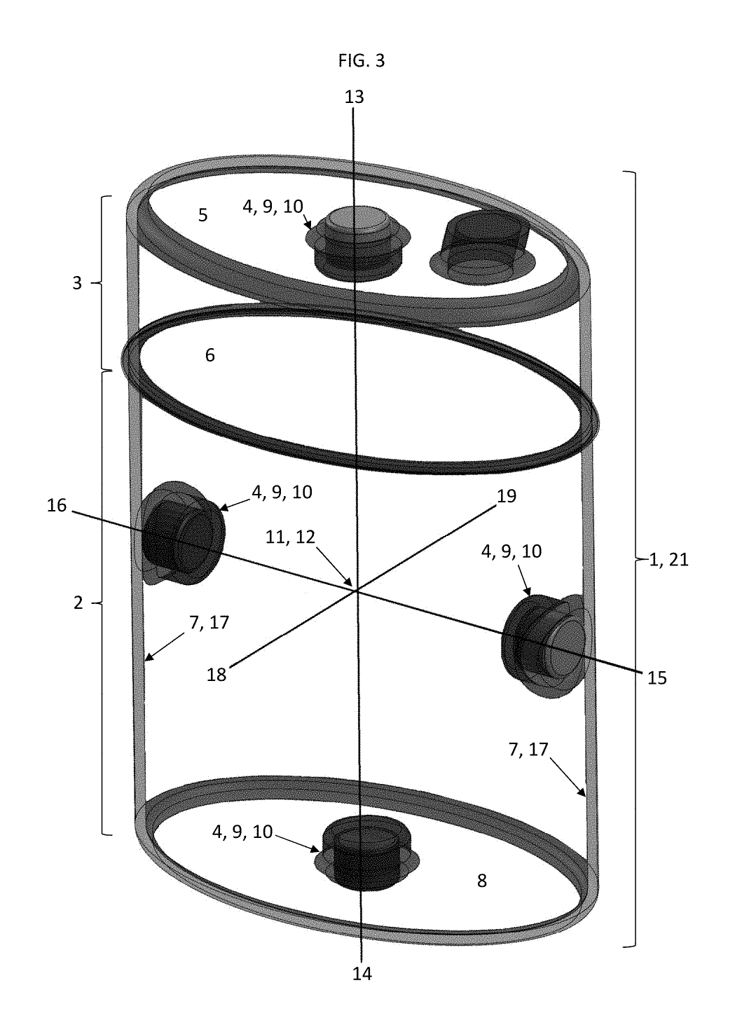

FIG. 4 is a view of the third embodiment of the beverage container including three pairs of magnets wherein the first set of paired magnets of the plurality of paired magnets, wherein one of the magnets is positioned along the positive z-axis in the top of the beverage container and the other magnet is positioned along the negative z-axis in the base of the beverage container, wherein the second set of paired magnets of the plurality of paired magnets, such that one of the magnets is positioned along the positive x-axis in one of the sides of the plurality of sides of the beverage container and the other magnet is positioned along the negative x-axis in one of the sides of the plurality of sides of the beverage container and wherein the third set of paired magnets of the plurality of paired magnets, such that one of the magnets is positioned along the positive y-axis in one of the sides of the plurality of sides of the beverage container and the other magnet is positioned along the negative y-axis in one of the sides of the plurality of sides of the beverage container.

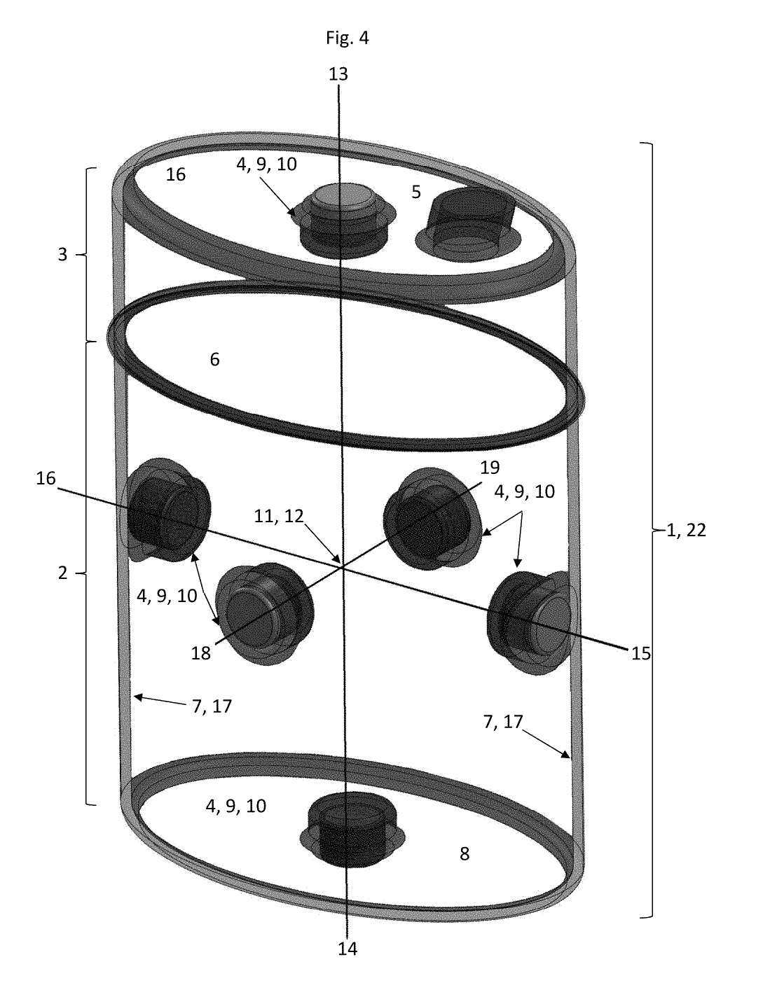

### DETAILED DESCRIPTION OF THE INVENTION

The present disclosure reveals a beverage container 1 with a plurality of paired magnets 4 positioned around the beverage container 1 is such a fashion so as to generate a magnetic field that acts upon liquid contained in the beverage container 1, said beverage container 1 comprising a main body 2, lid 3, and the plurality of paired magnets 4. The main body 2 comprises a top 5, an opening 6, a plurality of sides 7 and a base 8 and is capable of receiving and holding liquids, powders or gels. The lid 3 is such that the lid 3 fits over the opening 6 of the main body 2 to seal off the opening 6 to prevent the liquid, powder or gel from escaping from the beverage container 1 in the event the beverage container 1 is tipped or shaken. Each magnet 9 in a pair of magnets 10 of the plurality of paired magnets 4 is positioned in the beverage container 1 such that one magnet 9 is in one location of the beverage container 1 while another magnet 9 in the pair of magnets 10 is located on the opposite location of the beverage container 1. For the purpose of explanation of the disclosure only, the revealed disclosure will include the opening 6 in the main body 2 to be located at the top 5 of the beverage container 1.

In determining the placement of each pair of magnets 10 in the plurality of paired magnets 4 a center-point 11 of the beverage container 1 is identified based on the beverage container's 1 dimensions and from the center-point 11, Cartesian coordinates 12 can be extrapolated. Thus, a positive z-axis 13 intersects the top 5 of the beverage container 1 and a negative z-axis 14 intersects the base 8 of the beverage container 1; a positive x-axis 15 intersects one of the sides 17 of the plurality of sides 7 of the beverage container 1 and a negative x-axis 16 intersects one of the sides 17 of the plurality of sides 7 of the beverage container 1; and a positive y-axis 18 intersects one of the sides 17 of the plurality of sides 7 of the beverage container 1 and a negative y-axis 19 intersects one of the sides 17 of the plurality of sides 7 of the beverage container 1.

In a first embodiment 20 of the plurality of paired magnets 4 the first set of paired magnets 10 is positioned along the z-axis wherein the first magnet 9 is positioned along the positive z-axis 13, in the top 5 of the beverage container 1 and the other magnet 9 is positioned along the negative z-axis 14 in the base 8 of the beverage container 1.

In a second embodiment 21 of the plurality of paired magnets 4 there are two sets of paired magnets 10 wherein the first set of paired magnets 10 is positioned along the z-axis wherein the first magnet 9 is positioned along the positive z-axis 13, in the top 5 of the beverage container 1 and the other magnet 9 is positioned along the negative z-axis 14 in the base 8 of the beverage container 1, while the second set of paired magnets 10 is positioned along the x-axis, having the first magnet 9 positioned along the positive x-axis 15 in one side 17 of the plurality of sides 7 of the beverage container 1 and the second magnet 9 is positioned along the negative x-axis 14 in one side 17 of the plurality of sides 7 of the beverage container 1.

In a third embodiment 22 of the plurality of paired magnets there are three sets of paired magnets wherein the first set of paired magnets 10 is positioned along the z-axis wherein the first magnet 9 is positioned along the positive z-axis 13, in the top 5 of the beverage container 1 and the other magnet 9 is positioned along the negative z-axis 14 in the base 8 of the beverage container 1, while the second set of paired magnets 10 is positioned along the x-axis, having the first magnet 9 positioned along the positive x-axis 15 in one side 17 of the plurality of sides 7 of the beverage container 1 and the second magnet 9 is positioned along the negative x-axis 14 in one side 17 of the plurality of sides 7 of the beverage container 1, while the third set of paired magnets 10 is positioned along the y-axis, having the first magnet 9 positioned along the positive y-axis 18 in one side 17 of the plurality of sides 7 of the beverage container 1 and the second magnet 9 positioned along the negative y-axis 19 in one side 17 of the plurality of sides 7 of the beverage container 1.

In a fourth embodiment 20 of the plurality of paired magnets 4 the first set of paired magnets 10 is positioned along the x-axis, having the first magnet 9 positioned along the positive x-axis 15 in one side 17 of the plurality of sides 7 of the beverage container 1 and the second magnet 9 is positioned along the negative x-axis 14 in one side 17 of the plurality of sides 7 of the beverage container 1 along the x-axis.

In a fifth embodiment 21 of the plurality of paired magnets 4 there are two sets of paired magnets 10 wherein the first set of paired magnets 10 is positioned along the x-axis, having the first magnet 9 positioned along the positive x-axis 15 in one side 17 of the plurality of sides 7 of the beverage container 1 and the second magnet 9 is positioned along the negative x-axis 14 in one side 17 of the plurality of sides 7 of the beverage container 1, while the second set of paired magnets 10 is positioned along the y-axis, having the first magnet 9 positioned along the positive y-axis 18 in one side 17 of the plurality of sides 7 of the beverage container 1 and the second magnet 9 positioned along the negative y-axis 19 in one side 17 of the plurality of sides 7 of the beverage container 1.

Additional pairs of magnets 10 in the plurality of magnets 4 are possible, wherein each magnet 9 in the set of magnets 10 is positioned so as to oppose a magnet 9.

What is claimed:

1. A beverage container with a plurality of paired magnets positioned around the beverage container in such a fashion so as to generate a magnetic field that acts upon liquid contained in the beverage container to improve the taste of the liquid contained in the beverage container, said beverage container used for mixing, blending, storing, or drinking of liquids consisting of:
a beverage container consisting of a main body, lid, and the plurality of paired magnets;
the main body consisting of a top, an opening, a plurality of sides and a base;
the lid is such that the lid fits over the opening of the main body to seal off the opening;
wherein, regarding the plurality of magnets, in determining the placement of each pair of magnets in the plurality of paired magnets a center-point of the beverage container is identified based on the beverage container's dimensions and from the center-point, Cartesian coordinates can be extrapolated to generate a z-axis, an x-axis, and a y axis, thus, a positive z-axis intersects the top of the beverage container and a negative z-axis intersects the base of the beverage container, a positive x-axis intersects one of the sides of the plurality of sides of the beverage container and a negative x-axis intersects one of the sides of the plurality of sides of the beverage container, and a positive y-axis intersects one of the sides of the plurality of sides of the beverage container and a negative y-axis intersects one of the sides of the plurality of sides of the beverage container; and
each magnet in a pair of magnets of the plurality of paired magnets is positioned such that one magnet is located in the beverage container and the other magnet in the pair of magnets is positioned on the opposite side of the beverage container along at least one of the z-axis, x-axis, and/or y-axis so that the positioning of each pair of magnets of the plurality of paired magnets creates uniform interaction of the paired magnets.

2. The beverage container of claim 1 wherein one magnet in of the pair of magnets is positioned on the z-axis in the top of the beverage container along the positive z-axis while the second magnet of the pair of magnets is positioned in the base of the beverage container, along the negative z-axis.

3. The beverage container of claim 1 wherein there are two pairs of magnets of the plurality of paired magnets such that the first pair of magnets is positioned along the z-axis, has one magnet positioned in the top of the beverage container along the positive z-axis while the second magnet of the pair of magnets is positioned in the base of the beverage container, along the negative z-axis; and
the second pair of magnets is positioned along the x-axis, wherein one magnet is positioned in the side of the beverage container along the positive x-axis while the second magnet of the pair of magnets is positioned in the opposite of the beverage container, along the negative x-axis.

4. The beverage container of claim 1 wherein there are three pairs of magnets of the plurality of paired magnets such that the first pair of magnets is positioned along the z-axis with one magnet positioned in the top of the beverage container along the positive z-axis while the second magnet of the pair of magnets is positioned in the base of the beverage container, along the negative z-axis;
the second pair of magnets is positioned along the x-axis with one magnet positioned in the side of the beverage container along the positive x-axis while the second magnet of the pair of magnets is positioned in the opposite of the beverage container, along the negative x-axis; and
the third pair of magnets is positioned along the y-axis, with one magnet positioned in the side of the beverage container along the positive y-axis while the second magnet of the pair of magnets is positioned in the opposite of the beverage container, along the negative y-axis.

5. The beverage container of claim 1 wherein there is a single pair of magnets of the plurality of paired magnets such that the set of paired magnets of the plurality of paired magnets is positioned along the x-axis, having the first magnet positioned along the positive x-axis in one side of the plurality of sides of the beverage container and the second magnet is positioned along the negative x-axis in one side of the plurality of sides of the beverage container along the x-axis.

6. The beverage container of claim 1 wherein there are two pairs of magnets of the plurality of paired magnets such that the first set of paired magnets is positioned along the x-axis, having the first magnet positioned along the positive x-axis in one side of the plurality of sides of the beverage container and the second magnet is positioned along the negative x-axis in one side of the plurality of sides of the beverage container along the x-axis; and
a second set of paired magnets wherein the first magnet is positioned along the positive y-axis, which intersects one of the sides of the plurality of sides of the beverage container and the second magnet is positioned along a negative y-axis intersects one of the sides of the plurality of sides of the beverage container.
